(19) United States
(12) Patent Application Publication
(10) Pub. No.: US 2015/0256798 A1
(43) Pub. Date: Sep. 10, 2015

(54) IMAGE MONITORING SYSTEM AND CONTROL METHOD THEREOF

(71) Applicant: ALPHA IMAGING TECHNOLOGY CORP., Jhubei City (TW)

(72) Inventors: Tsung-Liang CHEN, Zhubei City (TW); Chih-Chan YEN, Jhubei City (TW)

(73) Assignee: ALPHA IMAGING TECHNOLOGY CORP., Jhubei City (TW)

(21) Appl. No.: 14/584,328

(22) Filed: Dec. 29, 2014

(30) Foreign Application Priority Data
Mar. 5, 2014 (TW) 103107348

(51) Int. Cl. H04N 7/18; G06F 3/16; G06F 3/01

(52) U.S. Cl. CPC H04N 7/181; G06F 3/017; G06F 3/165

(57) ABSTRACT

An image monitoring system includes a first control interface, a second control interface, a recording module, a storage device, and a control circuit. The recording module generates an image monitoring data. The storage device stores the image monitoring data. The control circuit is controlled by the first control interface and the second control interface. The control circuit performs a system operation in respect of the image monitoring data according to a first trigger signal when the first control interface receives the first trigger signal and performs the system operation in respect of the image monitoring data according to a second trigger signal when the second control interface receives the second trigger signal. The first control interface is different from the second control interface, and the first trigger signal is different from the second trigger signal.

This application claims the benefit of Taiwan application Serial No. 103107348, filed Mar. 5, 2014, the subject matter of which is incorporated therein by reference.

### BACKGROUND OF THE INVENTION

1. Field of the Invention

The invention relates to an image monitoring system and a control method thereof.

2. Description of the Related Art

In recent years, image monitoring system has been widely used in various fields such as crime prevention, real-time traffic monitoring, and disaster prevention. In short, regardless of home security, building monitoring, highway monitoring, cameras erected everywhere are capable of generating real-time image monitoring data, which may be transmitted to a remote device via network or cables. The user may browse the image monitoring data by the remote device to judge whether any emergent events have occurred. Conventional image monitoring systems are operated or controlled by using key boards.

Conventional image monitoring systems may be disposed at a higher position or a place other user may hardly reach. Besides, when driving a vehicle, if the user has to locate the press key of the conventional image monitoring systems, the user may easily get distracted and at risk of accidents. Thus, the control method of conventional image monitoring systems often causes great inconvenience to the user.

### SUMMARY OF THE INVENTION

The invention is directed to an image monitoring system and a control method thereof, in which the user may use different control interfaces to control system operation of the image monitoring system. When a control interface is not used to control the image monitoring system, the user may use other control interface to control the image monitoring system for system operation. Thus, the user has greater convenience in operation.

According to one embodiment of the invention, an image monitoring system is disclosed. The image monitoring system comprises a first control interface, a second control interface, a recording module, a storage device, and a control circuit. The recording module generates an image monitoring data. The storage device stores the image monitoring data. The control circuit is controlled by the first control interface and the second control interface. The control circuit performs a system operation in respect of the image monitoring data according to a first trigger signal when the first control interface receives the first trigger signal and performs the system operation in respect of the image monitoring data according to a second trigger signal when the second control interface receives the second trigger signal. The first control interface is different from the second control interface, and the first trigger signal is different from the second trigger signal.

According to another embodiment of the invention, a control method of an image monitoring system is disclosed. The control method of an image monitoring system comprises: providing a first control interface; providing a second control interface; performing a system operation in respect of the image monitoring data according to the first trigger signal when the first control interface receives the first trigger signal; performing a system operation according to the second trigger signal when the second control interface receives the second trigger signal, wherein the first control interface is different from the second control interface, and the first trigger signal is different from the second trigger signal.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a schematic diagram of an image monitoring system according to an embodiment of the invention.

FIG. 2 is a schematic diagram of transmitting the image monitoring data to a Wi-Fi base station.

FIG. 3 is a schematic diagram of transmitting the image monitoring data to a mobile communication device.

FIG. 4 is a flowchart of generating the image monitoring data according to an embodiment of the invention.

FIG. 5 is a schematic diagram of controlling the image monitoring system by using a voice command.

FIG. 6 is a flowchart of recognizing voice command.

FIG. 7 is a schematic diagram of controlling the image monitoring system by using a hand gesture command.

FIG. 8 is a flowchart of recognizing a hand gesture command.

### DETAILED DESCRIPTION OF THE INVENTION

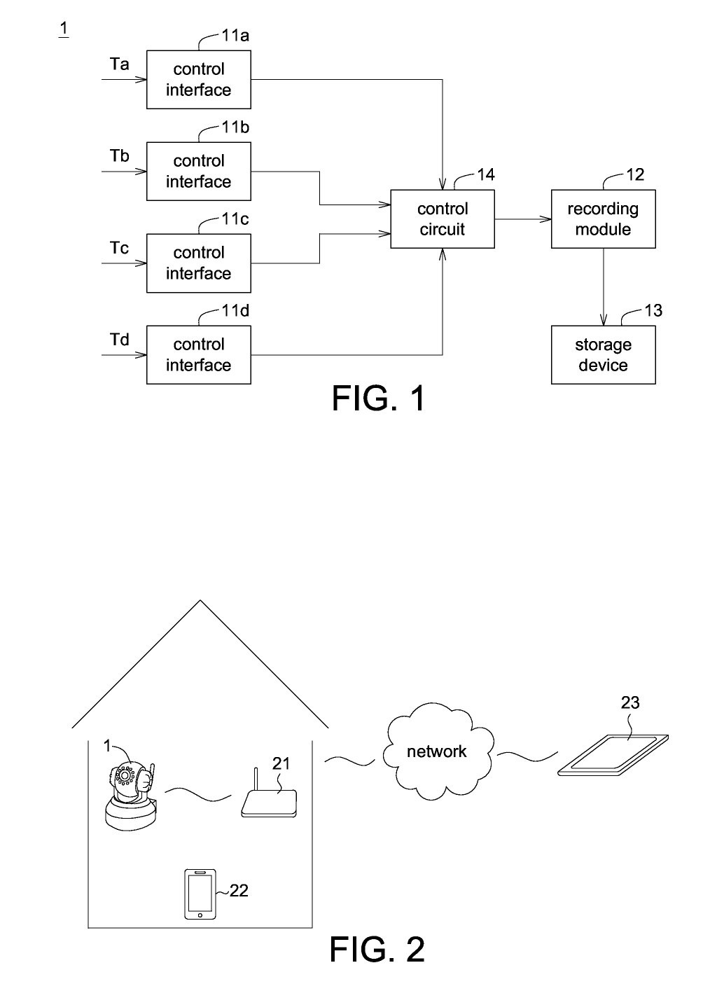

Referring to FIG. 1, a schematic diagram of an image monitoring system according to an embodiment of the invention is shown. The image monitoring system 1 includes control interfaces 11a, 11b, 11c and 11d, a recording module 12, a storage device 13 and a control circuit 14. The recording module 12 generates an image monitoring data, and the storage device 13 stores the image monitoring data. The control circuit 14 is controlled controlled by the control interfaces 11a, 11b, 11c and 11d which are selected from a group including a key group, a network module and a man-machine interface. The man-machine interface may be realized by a hand gesture control interface or a voice control interface. The recording module 12 may be realized by a lens module and a video processor. The control circuit 14 may also be realized by a central processor.

When the control interface 11a receives a trigger signal Ta, the control circuit 14 performs a system operation in respect of the image monitoring data according to the trigger signal Ta. When the control interface 11b receives a trigger signal Tb, the control circuit 14 performs the system operation in respect of the image monitoring data according to the trigger signal Tb. When the control interface 11c receives a trigger signal Tc, the control circuit 14 performs the system operation in respect of the image monitoring data according to the trigger signal Tc. When the control interface 11d receives the trigger signal Td, the control circuit 14 performs the system operation in respect of the image monitoring data according to the trigger signal Td. The system operation is such as system booting, system shutdown, recording, or switching of network link. The system operation in respect of recording is such as controlling the recording module to perform a cyclic recording operation or an event-triggered recording operation. The system operation in respect of the switching of network link is implemented by controlling the network module to link to a Wi-Fi base station or a mobile communication device.

The control interfaces 11a, 11b, 11c and 11d are different from one another, and the trigger signals Ta, Tb, Tc and Td are also different from one another. For example, the control interface 11a is realized by a key group, and the trigger signal Ta is a user's pressing action. The control interface 11b is realized by a network module, and the trigger signal Tb is realized by a wireless signal. The control interface 11c is realized by a lens module, a video processor and a man-machine interface processor, and the trigger signal Tc is realized by a user's hand gesture command. The control interface 11d is realized by a microphone, an audio processor and the man-machine interface processor, and the trigger signal Td is realized by a user's voice command. The control circuit 14 performs a system operation in respect of the image monitoring data according to the trigger signal Ta, Tb, Tc or Td. In other words, the user may choose the pressing action, the wireless signal, the hand gesture gesture command or the voice command to control the image monitoring system 1 to perform the system operation. Thus, if anyone of the control interfaces 11a, 11b, 11c and 11d is not used to control the image monitoring system 1, the user still may use other control interface to control the image monitoring system 1 to perform the system operation.

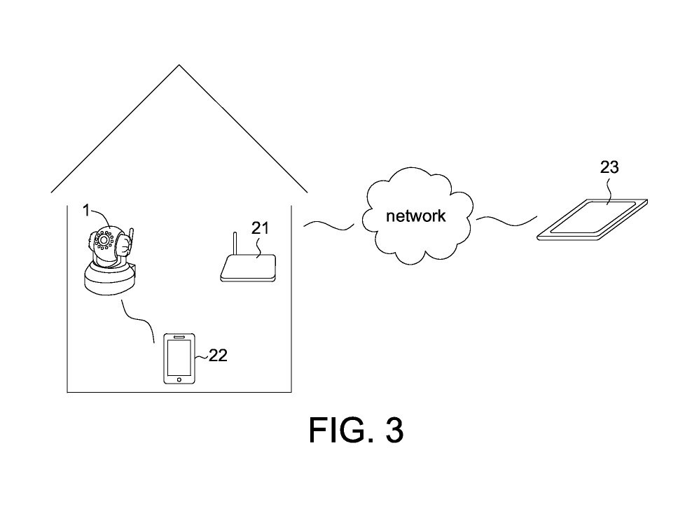

Refer to FIG. 1, FIG. 2 and FIG. 3 at the same time. FIG. 2 is a schematic diagram of transmitting the image monitoring data to a Wi-Fi base station. FIG. 3 is a schematic diagram of transmitting the image monitoring data to a mobile communication device. When the control interface 11b is a network module and is used for transmitting the image monitoring data, the image monitoring system 1 still may use the trigger signal Ta, Tc or Td to control the network module to link to the Wi-Fi base station 21 or the mobile communication device 22. The Wi-Fi base station 21 may be realized by a Wi-Fi access point (AP), and the mobile communication device 22 may be realized by a smartphone.

When the network module links to the indoor Wi-Fi base station 21, the image monitoring system 1 acts as a Wi-Fi client. The image monitoring data is transmitted the Wi-Fi base station 21 via Wi-Fi and is further transmitted to a remote device 23 (illustrated in FIG. 2) via network. The remote device 23 may be realized by a PC, a notebook or a tablet PC. When the network module links to the indoor mobile communication device 22, the image monitoring system 1 acts as a WI-FI access point. The image monitoring system 1 transmits the image monitoring data to the mobile communication device 22 via WI-FI. Since the image monitoring system 1 acts as a WI-FI client when the network module links to the indoor Wi-Fi base station 21, the user may no longer command the image monitoring system 1 to link to the mobile communication device 22 via WI-FI. Meanwhile, the user may command the image monitoring system 1 to link to the mobile communication device 22 by using a pressing action, a hand gesture command or a voice command. Thus, the user has greater convenience in operation.

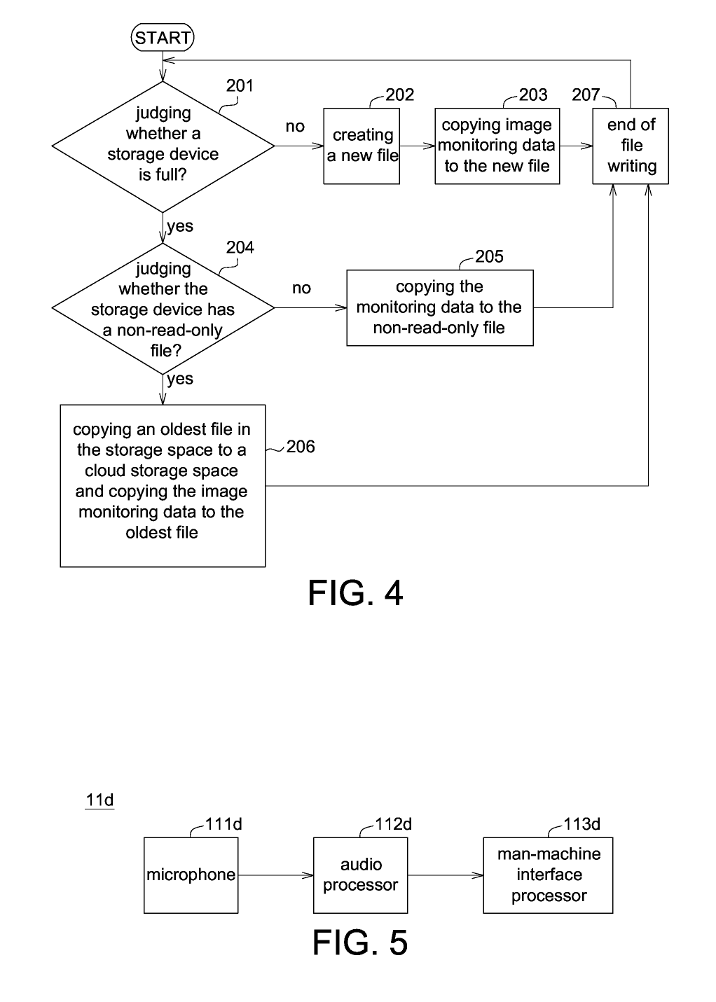

Refer to both FIG. 1 and FIG. 4. FIG. 4 is a flowchart of generating the image monitoring data according to an embodiment of the invention. The recording module 12 may perform a cyclic recording operation or an event-triggered recording operation. When the recording module 12 performs the cyclic recording operation, the user may set a time duration for each recording file. Once the recording time is over the pre-set time duration, the recording module 12 records into the next recording file. When the recording module 12 performs the event-triggered recording operation, the recording module 12 may be controlled by the control interface 11a, 11b, 11c or 11d to perform the event-triggered recording operation. The recording module 12 marks the image monitoring data generated from the event-triggered recording recording operation as a read-only file, and further copies the read-only file to a cloud storage space.

The process of generating image monitoring data by the recording module 12 is as follows. At step 201, whether a storage space of a storage device 13 is full is judged by the recording module 12. If the storage space is not full, the process proceeds to step 202. In step 202, a new file is created by by the recording module 12. In step 203, image monitoring data is written to the new file by the recording module 12. In step 207, file writing is end by the recording module 12. Conversely, if the storage space is full, then the process proceeds to step 204. In step 204, whether the storage space has a non-read-only file is judged by the recording module 12. If the storage space has the non-read-only file, then the process proceeds to step 205. In step 205, the image monitoring data is copied to non-read-only file by the recording module 12. In step 207, file writing is ended by the recording module 12. Conversely, if the storage space does not have the non-read-only file, then the the process proceeds to step 206. In step 206, an oldest file in the storage space is copied to a cloud storage space by the recording module 12 and then then the image monitoring data is copied to the oldest file. In step 207, file writing is ended by the recording module 12.

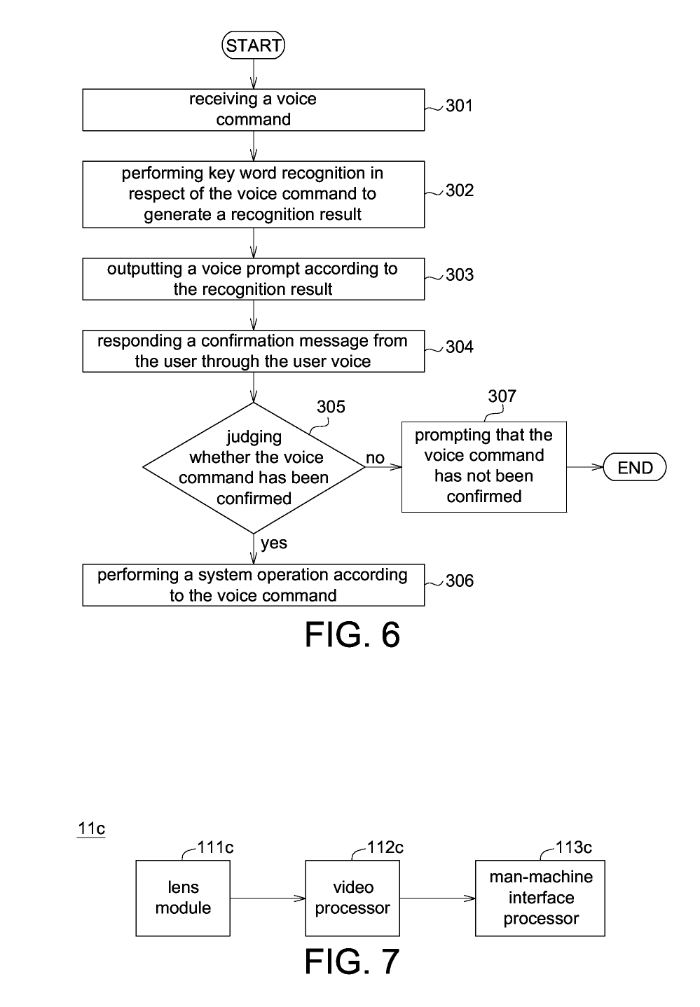

Refer to FIG. 1, FIG. 5 and FIG. 6 at the same time. FIG. 5 is a schematic diagram of controlling the image monitoring system by using a voice command. FIG. 6 is a flowchart of recognizing voice command. The control interface 11d of FIG. 5 is exemplified by a microphone 111d, an audio processor 112d and a man-machine interface processor 113d. The audio processor 112d performs an audio processing operation on a user's voice command and further outputs a processed result to the man-machine interface interface processor 113d. The process of recognizing a voice command is as follows. At step 301, a voice command is received by the man-machine interface processor 113d. At step 302, key word recognition is performed by the man-machine interface processor 113d on the voice command to generate generate a recognition result. At step 303, a voice prompt is outputted by the man-machine interface processor 113d according to the recognition result. At step 304, a confirmation message is responded from the user through the user user voice. At step 305, the confirmation message is processed by the man-machine interface processor 113d, and whether the voice command has been confirmed is judged according to the processed confirmation message. If If it is judged that the voice command has been confirmed by the user, then the process proceeds to step 306. In step 306, a system operation is performed by the control circuit 14 according to the voice command. Conversely, if it is judged that the voice command has not yet been confirmed, then the process proceeds to step 307. In step 307, the man-machine interface processor 113d prompts that the user has been not confirmed the voice command. The process of recognizing a voice command is ended after the step 307.

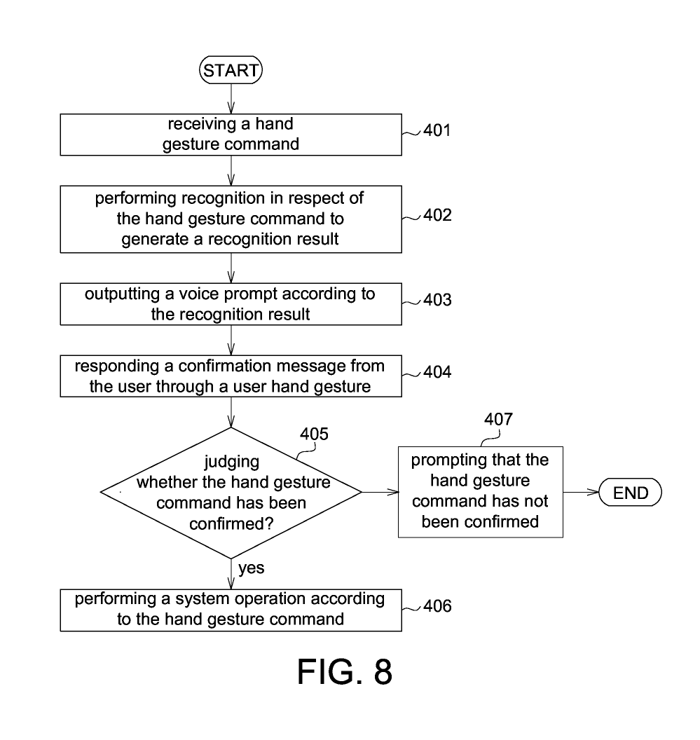

Refer to FIG. 1, FIG. 7 and FIG. 8 at the same time. FIG. 7 is a schematic diagram of controlling the image monitoring system by using a hand hand gesture command. FIG. 8 is a flowchart of recognizing a hand gesture command. The control interface 11c of FIG. 7 is exemplified by a lens module 111c, a video processor 112c and a man-machine interface processor 113c. The video processor 112c performs a video processing operation on a user's hand gesture command and further outputs a processed result to the man-machine interface processor 113c. The process of recognizing a gesture command is as follows. At step 401, a hand gesture command is received by the man-machine interface processor 113c. At step 402, the man-machine interface processor 113c recognizes the hand gesture command to generate a a recognition result. At step 403, a voice prompt is outputted by the man-machine interface processor 113d according to the recognition result. At step 404, a confirmation message is responded by the user through a hand gesture. At step 405, the confirmation message is processed by the man-machine interface processor 113c and whether the hand gesture command has been confirmed is judged according to the processed confirmation message. If it is judged that the hand gesture command has been been confirmed by the user, then the process proceeds to step 406. In step 406, a system operation is performed by the control circuit 14 according to the hand gesture command. Conversely, if it is judged that the hand gesture command has not yet been confirmed, then the process proceeds to step 407.

In step 407, the man-machine interface processor 113d prompts that the user has been not confirmed the hand gesture command. The process of recognizing a hand gesture command is ended after the step 407.

According to the image monitoring system and the control method thereof disclosed in above embodiments, the user may use different control interfaces to control system operation of the image monitoring system. When a control interface is not used to control the image monitoring system 1, the user may use other control interface to control the image monitoring system 1 to perform system operation. Thus, the user has greater convenience in operation.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image monitoring system, comprising:
a first control interface;
a second control interface;
a recording module for generating an image monitoring data;
a storage device for storing the image monitoring data; and
a control circuit, controlled by the first control interface and the second control interface,
wherein the control circuit performs a system operation in respect of the image monitoring data according to a first trigger signal when the first control interface receives the first trigger signal,
the control circuit performs the system operation according to a second trigger signal when the second control interface receives the second trigger signal,
the first control interface is different from the second control interface, and
the first trigger signal is different from the second trigger signal.

2. The image monitoring system according to 1, wherein the first control interface and the second control interface are selected from a group including a key group, a network module and a man-machine interface.

3. The image monitoring system according to 2, wherein the system operation controls the network module to link to a wireless base station or a mobile communication device, and when the first control interface is the network module and the network module transmits the image monitoring data, the control circuit controls the network module to link to the wireless base station or the mobile communication device according to the second trigger signal.

4. The image monitoring system according to 1, wherein the man-machine interface is a voice control interface or a hand gesture control interface.

5. The image monitoring system according to 1, wherein the system operation controls a network module to link to a wireless base station or a mobile communication device.

6. The image monitoring system according to 1, wherein the system operation controls the recording module to perform a cyclic recording operation.

7. The image monitoring system according to 1, wherein the system operation controls the recording module to perform an event-triggered recording operation.

8. The image monitoring system according to 7, wherein the recording module marks the image monitoring data generated from the event-triggered recording operation as a read-only file, and copies the read-only file to a cloud storage space.

9. The image monitoring system according to 1, wherein
the recording module judges whether the storage device is full;
if the storage space is not full, the recording module creates a new file and writes the image monitoring data to the new file;
if the storage space is full, then the recording module judges whether the storage space has a non-read-only file; and
if the storage space has the non-read-only file, then the recording module copies the image monitoring data to the non-read-only file.

10. The image monitoring system according to 9, wherein if the storage space does not have the non-read-only file, then the recording module copies an oldest file in the storage space to a cloud storage space and copies the image monitoring data to the oldest file.

11. A control method of an image monitoring system, comprising:
providing a first control interface;
providing a second control interface;
performing a system operation in respect of an image monitoring data according to a first trigger signal when the first control interface receives the first trigger signal; and
performing the system operation according to a second trigger signal when the second control interface receives the second trigger signal, wherein the first control interface is different from the second control interface, and the first trigger signal is different from the second trigger signal.

12. The control method according to 11, wherein the first control interface and the second control interface are selected from a group including a key group, a network module and a man-machine interface.

13. The control method according to 12, wherein the system operation controls a network module to link to a wireless base station or a mobile communication device, and when the first control interface is the network module and the network module transmits the image monitoring data, the network module is controlled to link to the wireless base station or the mobile communication device according to the second trigger signal.

14. The control method according to 11, wherein the man-machine interface is a voice control interface or a hand gesture control interface.

15. The control method according to 11, wherein the system operation controls a network module to link to a wireless base station or a mobile communication device.

16. The control method according to 11, wherein the system operation controls a recording module to perform a cyclic recording operation.

17. The control method according to 11, wherein the system operation controls a recording module to perform an event-triggered recording operation.

18. The control method according to 17, wherein the image monitoring data generated from the event-triggered recording operation is marked as a read-only file, and the read-only file is copied to a cloud storage space.

19. The control method according to 11, further comprising:
judging whether a storage space is full;
creating a new file and writing the image monitoring data to the new file if the storage space is not full;
judging whether the storage space has a non-read-only file if the storage space is full; and
copying the image monitoring data to the non-read-only file if the storage space has the non-read-only file.

20. The control method according to 19, wherein if the storage space does not have the non-read-only file, then an oldest file of the storage space is copied to a cloud storage space, and the image monitoring data is copied to the oldest file.
